(19) United States
(12) Patent Application Publication
(10) Pub. No.: US 2010/0186991 A1
(43) Pub. Date: Jul. 29, 2010

(54) CONDUCTIVE BUMPS, WIRE LOOPS INCLUDING THE IMPROVED CONDUCTIVE BUMPS, AND METHODS OF FORMING THE SAME

(75) Inventors: Kazunori Tajima, Kurume Fukuoka (JP); Wei Qin, Lansdale, PA (US); Stephen E. Babinetz, Lansdale, PA (US)

Correspondence Address: KULICKE AND SOFFA INDUSTRIES, INC., 1005 VIRGINIA DRIVE, FORT WASHINGTON, PA, 19034, US

(73) Assignee: KULICKE AND SOFFA INDUSTRIES, INC., Fort Washington, PA (US)

(21) Appl. No.: 11/917,115

(22) PCT Filed: Oct. 18, 2006
(86) PCT No.: PCT/US06/40886

§ 371 Date: Dec. 10, 2007

(51) Int. Cl. H01B 5/00; B23K 31/02

(52) U.S. Cl. 174/126.1; 228/155

(57) ABSTRACT

A method of forming a conductive bump using a wire-bonding machine is provided. The method includes (a) depositing a free air ball bump on a contact pad of a semiconductor element, (b) forming a first fold of wire on the deposited free air ball bump, and (c) forming a second fold of wire on the first fold of wire.

### FIELD OF THE INVENTION

The present invention relates to wire bonding of semiconductor devices, and more particularly, to improved conductive bumps and wire loops formed using a wire bonding machine.

### BACKGROUND OF THE INVENTION

In the manufacturer of various semiconductor devices, wire bonding techniques are often used to connect components in the devices. For example, wire loops are often used to provide interconnection between a semiconductor chip/die and contacts on a leadframe or the like. An exemplary conventional wire bonding operation involves (1) bonding to a first bonding location on a semiconductor die (e.g., using ball bonding), (2) extending a wire toward a second bonding location on a leadframe, (3) bonding the end of the extended wire to the second bonding location, and (4) cutting the wire.

In certain applications it is desirable to form conductive bumps on contact pads of a semiconductor die or the like using a well known technique sometimes referred to a “bump bonding” or “stud bumping.” In such an application it is often desirable to form conductive bumps having a high height-to-diameter ratio. Conventional approaches to forming conductive bumps having a have a high height-to-diameter ratio include stacking bumps; however, certain challenges exist when stacking bumps including (1) the bump forming speed, (2) alignment of the stacked bumps, and (3) issues with fine pitches due to multiple impacts.

When forming wire loops one conventional technique includes (1) forming a conductive bump at the second bond site, and (2) forming a wire loop extending from the first bond site to the conductive bump previously formed at the second bond site. For example, the first bond site may be a bond pad on a semiconductor die, and the second bond site may be a bond pad on a leadframe. Unfortunately, often such a technique does not provide adequate clearance between the wire loop and the surface of the semiconductor die (e.g., the conductive bump on which the second bond is formed has an inadequate height in certain applications).

Thus, it would be desirable to provide improved conductive bumps, wire loops, and methods of forming such conductive bumps and wire loops.

### SUMMARY OF THE INVENTION

According to an exemplary embodiment of the present invention, a method of forming a conductive bump using a wire-bonding machine is provided. The method includes (a) depositing a free air ball bump on a contact pad of a semiconductor element, (b) forming a first fold of wire on the deposited free air ball bump, and (c) forming a second fold of wire on the first fold of wire.

According to another exemplary embodiment of the present invention, a method of bonding a wire between a first bonding location and a second bonding location using a wire-bonding machine is provided. The method includes (a) forming a conductive bump at a second bonding location, and (b) extending a length of wire between the first bonding location and the formed conductive bump. The step of forming the conductive bump includes: (1) depositing a free air ball bump on a contact pad of a semiconductor element, (2) forming a first fold of wire on the deposited free air ball bump, and (3) forming a second fold of wire on the first fold.

These and other methods of the present invention may be embodied as an apparatus (e.g., as part of the intelligence of a wire bonding machine), or as computer program instructions on a computer readable carrier (e.g., a computer readable carrier used in connection with a wire bonding machine).

According to yet another exemplary embodiment of the present invention, a conductive bump is provided. The conductive bump includes a free air ball bump portion of a length of wire, a first fold of wire on the free air ball bump portion, and a second fold of wire on the first fold of wire.

According to yet another exemplary embodiment of the present invention, a wire loop providing electrical interconnection between a first bonding location and a second bonding location is provided. The wire loop includes a conductive bump positioned at the second bonding location. The conductive bump includes a free air ball bump portion formed from a length of wire, a first fold of wire on the free air ball bump portion, and a second fold of wire on the first fold of wire. The wire loop also includes a length of wire extending between the first bonding location and the conductive bump.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIGS. 1-9A are a series of side view diagrams illustrating a method of forming a conductive bump in accordance with an exemplary embodiment of the present invention;

FIGS. 9B-11 are a series of side view diagrams following the steps shown in FIGS. 1-7 collectively illustrating a method of forming a conductive bump in accordance with an exemplary embodiment of the present invention;

FIGS. 12-14 are a series of side view diagrams illustrating formation of a wire loop in accordance with an exemplary embodiment of the present invention;

FIGS. 15A-15B are side view diagrams illustrating an increased height of a conductive bump in accordance with an exemplary embodiment of the present invention;

FIGS. 16A-16B are top view diagrams of conductive bumps formed in accordance with an exemplary embodiment of the present invention; and

FIGS. 17A-17B are diagrams illustrating motions of forming conductive bumps in accordance with various exemplary embodiments of the present invention.

### DETAILED DESCRIPTION OF THE INVENTION

U.S. Pat. Nos. 5,205,463, 6,062,462, and 6,156,990, as well as United States Patent Publication No. 2004/0152292, relate to wire bonding technology, and are herein incorporated by reference in their entirety.

As used herein, the terms “contact pad” and “bond pad” are intended to refer to any conductive region/surface to which bonding (e.g., ball bonding) is done.

As used herein, the term semiconductor element is intended to refer to any of a broad class of elements used in semiconductor processing including semiconductor wafers, singulated semiconductor dies/chips, substrates (e.g., leadframes), etc.

As used herein, the term “free air ball bump” is not intended to be limited to any particular shape, and is intended to cover ball bumps formed using a electronic flame off device, and ball bumps formed without such a device.

In certain exemplary embodiments, the present invention relates to a method of forming conductive bumps having an improved height-to-diameter ratio, for example, a greater height-to-diameter ratio. Such conductive bumps may be formed by depositing a free air ball bump (e.g., through known ball bumping processes) and then extending the wire connected to the deposited bump to form multiple folds of wire on top of the deposited bump. Through such a technique, the height of the resulting conductive bump may be increased as desired, while the width of the conductive bump may stay the same.

Conductive bumps formed according to the present invention may be used in a number of known applications. One such exemplary application would be conductive bumps (e.g., stud bumps) formed on a semiconductor device (e.g., a semiconductor wafer) used for flip chip interconnections.

Conductive bumps formed according to the present invention may also be used in the formation of wire loops, for example, to provide a larger (and/or higher) target for wire bond formation. For example, after a conductive bump is formed at the second bond site (e.g., on a leadframe bond pad, on a semiconductor die bond pad, etc.), a length of wire may be extended between a bond pad of a first bond site (e.g., a leadframe bond pad, a semiconductor die bond pad, etc.) and the conductive bump already formed at the second bond site. In other embodiments, conductive bumps according to the present invention may be formed at each of a first bonding location and a second bonding location, where a length of wire is extended (e.g., stitch bonded) between the two conductive bumps. Other configurations are also contemplated.

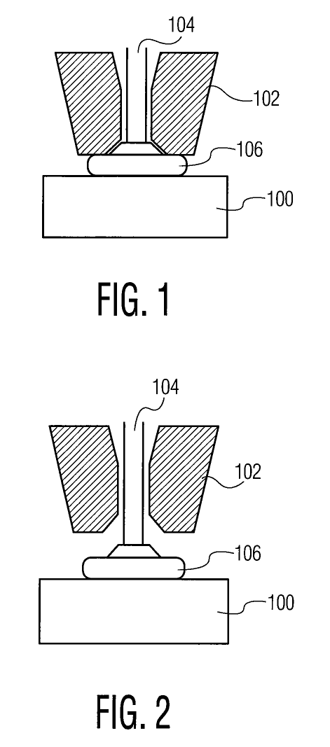

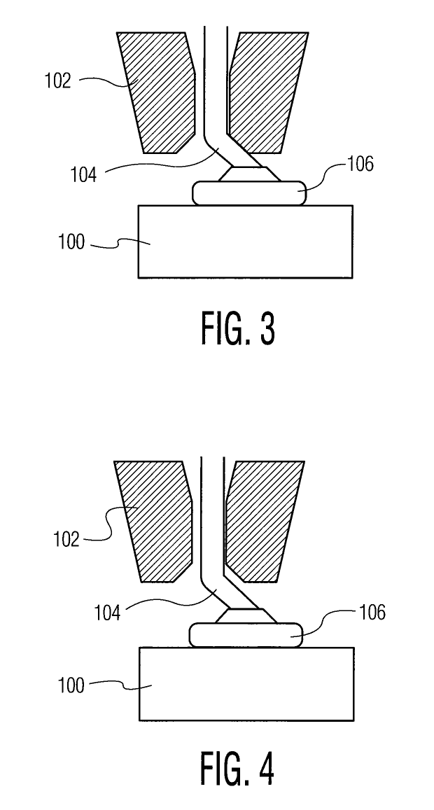

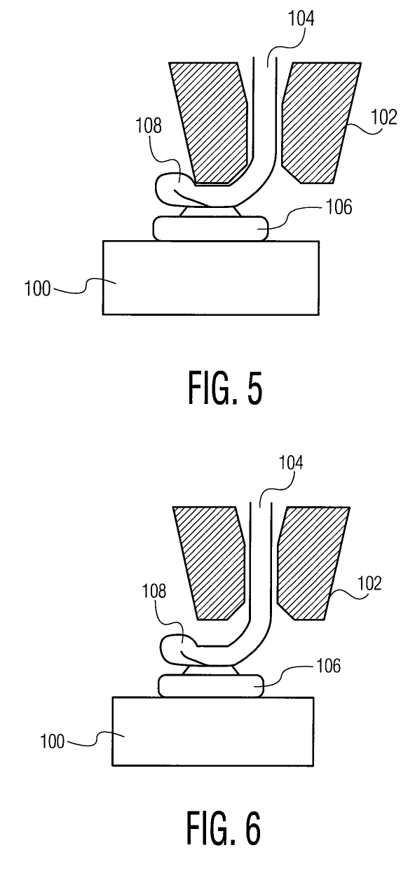

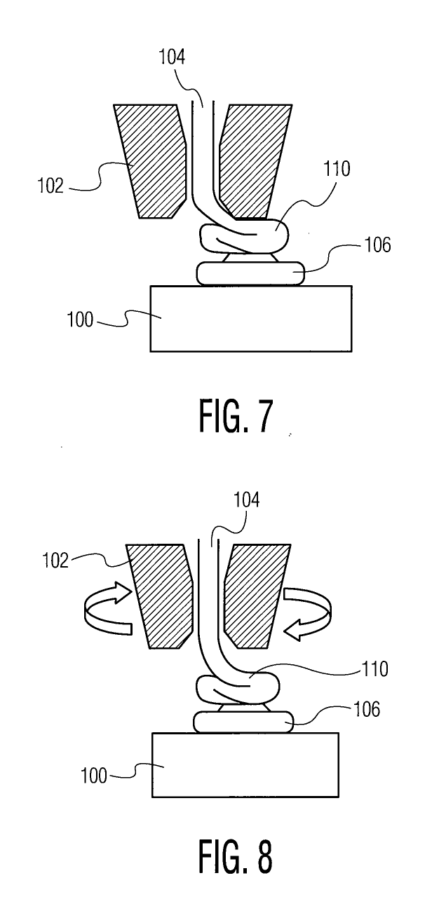

FIGS. 1-9A are a series of side view diagrams illustrating a method of forming a conductive bump in accordance with an exemplary embodiment of the present invention. At FIG. 1, bonding tool 102 (e.g., capillary tool 102) is used to deposit ball bump 106 on a bond pad of semiconductor die 100 (bond pads on semiconductor die 100 are not shown in the Figures). As shown in FIG. 2, with ball bump 106 still connected to wire 104, capillary 102 is raised above the surface of ball bump 106. FIG. 3 illustrates capillary 102 being moved in a lateral (i.e., horizontal) direction, and at FIG. 4 capillary 102 is moved in a vertical direction to payout a small length of wire. At FIG. 5, first fold of wire 108 is formed by moving capillary 102 down and horizontally. FIG. 6 illustrates capillary 102 being moved in a vertical direction to payout a small portion of wire, and FIG. 7 illustrates capillary 102 being moved down and horizontally (in the direction opposite to direction used to form first fold 108) to form second fold 110.

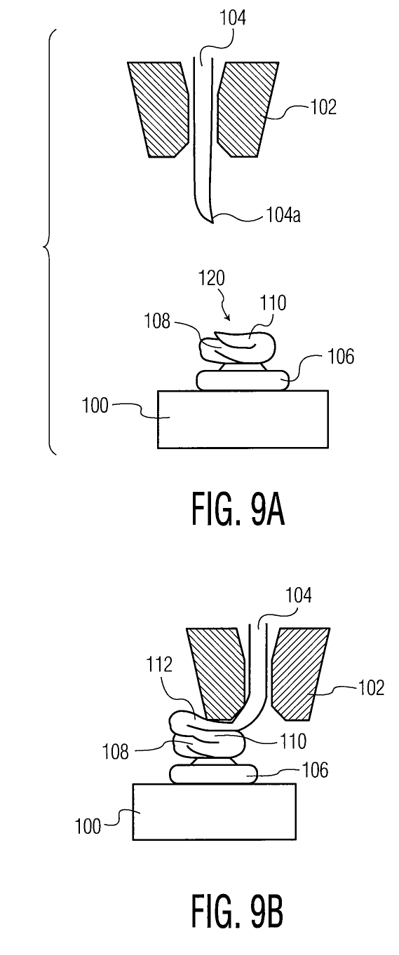

After the step shown at FIG. 7, a number of other steps may be completed in accordance with the various exemplary embodiments of the present invention. FIGS. 8-9A illustrate one exemplary embodiment, while FIGS. 9B-11 illustrate another exemplary embodiment.

Referring specifically to FIG. 8, capillary 102 is moved in a vertical direction (following the position shown in FIG. 7) to payout a small portion of wire, which motion may be followed by (1) a rapid oscillating horizontal movement and/or (2) an application of ultrasonic energy. The distance of the rapid oscillating horizontal movement may vary based on a number of factors (e.g., wire diameter, wire material, capillary hole diameter, capillary material, etc.). The purpose of this rapid oscillating motion is to weaken the wire tail to facilitate breakage and/or to prevent a non-stick failure. At FIG. 9A, the wire clamp (not shown) is closed, and capillary 102 is moved in a vertical direction to tear wire tail 104a. Thus, according to the exemplary embodiment of the present invention shown in FIGS. 1-9A, conductive bump 120 (shown in FIG. 9A) is formed. Conductive bump 120 includes (1) ball bump 106, (2) first fold of wire 108, and (3) second fold of wire 110.

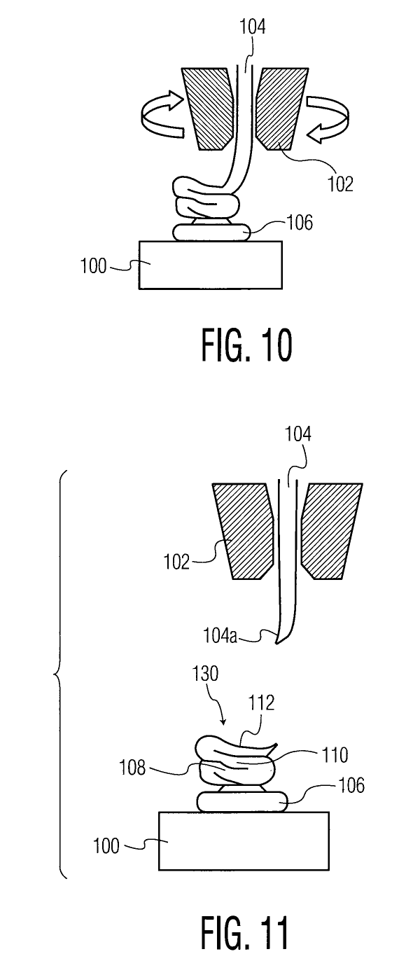

Alternatively, following the position shown in FIG. 7, capillary 102 may be raised (e.g., to a position similar to that shown in FIG. 8) and then lowered and moved horizontally to form third fold of wire 112, as shown in FIG. 9B. As shown in FIG. 10, capillary 102 is then moved in a vertical direction (following the position shown in FIG. 9B) to payout a small portion of wire, which motion may be followed by (1) a rapid oscillating horizontal movement and/or (2) an application of ultrasonic energy. The distance of the rapid oscillating horizontal movement may vary based on a number of factors (e.g., wire diameter, wire material, capillary hole diameter, capillary material, etc.). The purpose of this rapid oscillating motion is to weaken the wire tail to facilitate breakage and/or to prevent a non-stick failure. At FIG. 11, the wire clamp (not shown) is closed, and capillary 102 is moved in a vertical direction to tear wire tail 104a. Thus, according to the exemplary embodiment of the present invention shown in FIGS. 1-7 and FIGS. 9B-11, conductive bump 130 (shown in FIG. 11) is formed. Conductive bump 130 includes (1) ball bump 106, (2) first fold of wire 108, (3) second fold of wire 110, and (4) third fold of wire 112.

Thus, according to the present invention, conductive bumps having two folds of wire (FIG. 9A), three folds of wire (FIG. 11), and four, five or more folds of wire may be created. The process for forming additional folds of wire (e.g., a fourth fold, a fifth fold, etc.) may be similar to that shown in the figures.

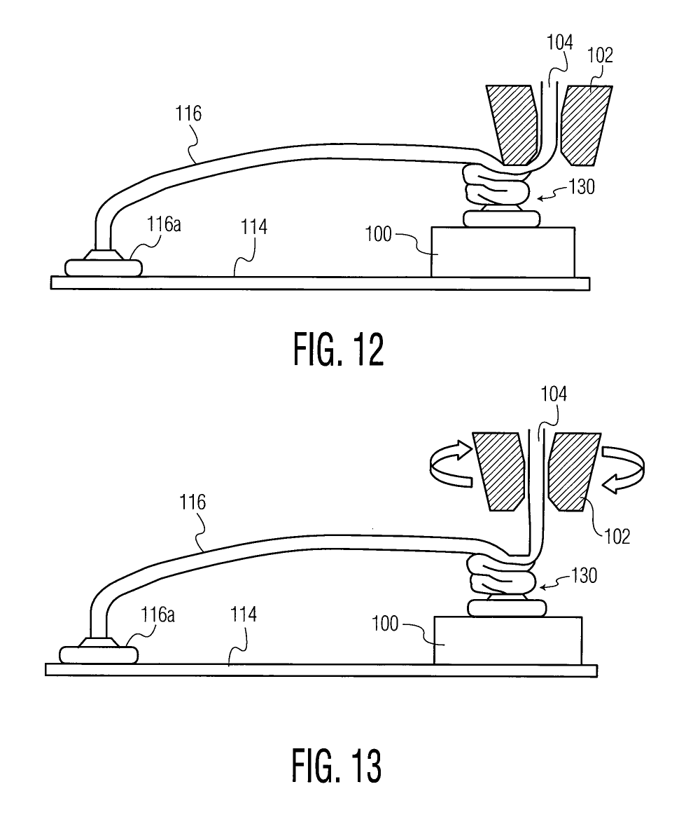

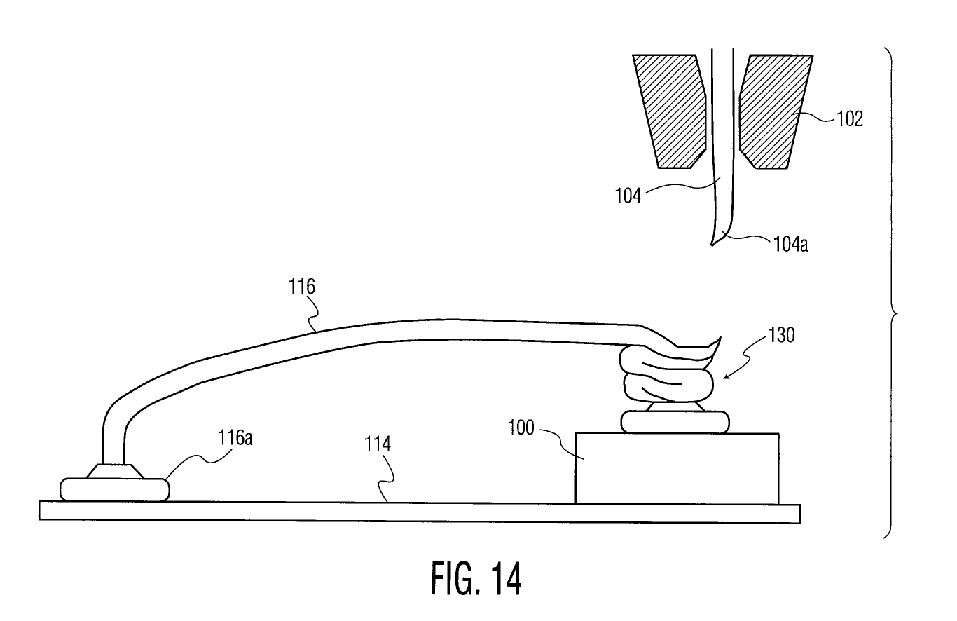

FIGS. 12-14 are a series of side view diagrams illustrating formation of a wire loop in accordance with an exemplary embodiment of the present invention. Referring specifically to FIG. 12, semiconductor die 100 is provided on substrate 114 (e.g., a leadframe). Conductive bump 130 (conductive bump 130 shown in FIG. 11) is formed on a bond pad (not shown) of semiconductor die 100. Then length of wire 116 is formed between a bond pad of substrate 114 and conductive bump 130. More specifically, conductive bump 130 is formed at the second bond site (i.e., a bond pad of semiconductor die 100). Then, ball bond 116a is formed at the first bond site (i.e., a bond pad of substrate 114), and length of wire 116 is extended from ball bond 116a to conductive bump 130. As shown in FIG. 13, capillary 102 is then moved in a vertical direction to payout a small portion of wire, which motion may be followed by (1) a rapid oscillating horizontal movement and/or (2) an application of ultrasonic energy, thus weakening the wire tail to facilitate breakage and/or to prevent a non-stick failure. At FIG. 14, the wire clamp (not shown) is closed, and capillary 102 is moved in a vertical direction to tear wire tail 104a.

Thus, wire loops may be formed according to the present invention, using conductive bumps formed according to the present invention. Of course, any conductive bump formed according to the present invention (e.g., a conductive bump having two, four, five or more folds of wire) could replace conductive bump 130 in FIGS. 12-14. Further, a conductive bump formed according to the present invention could be integrated into the first bond site (on a bond pad of leadframe 114 shown in FIGS. 12-14) as opposed to the second bond site (on a bond pad of semiconductor die 100 shown in FIGS. 12-14). Further still, conductive bumps formed according to the present invention could be integrated into the first bond site and the second bond site of a wire loop, where a length of wire may be extended between the two conductive bumps.

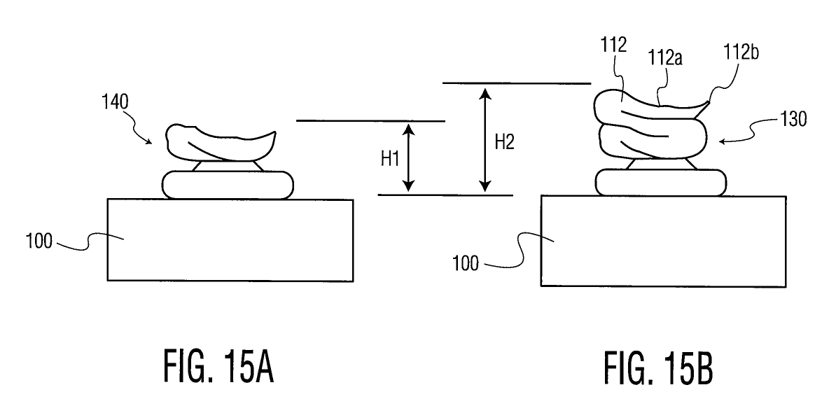

FIGS. 15A-15B are side view diagrams illustrating an increased height of a conductive bump in accordance with an exemplary embodiment of the present invention. More specifically, FIG. 15A illustrates a conductive bump having a single fold and a height H1, where FIG. 15B illustrates conductive bump 130 according to the present invention (the same bump 130 shown in FIG. 11) having three folds of wire and having a height H2. Conductive bump 130, as shown in FIG. 15B, includes top surface 112a (i.e., the top of third fold of wire 112) and wire tail/tip 112b (i.e., the end of third fold of wire 112).

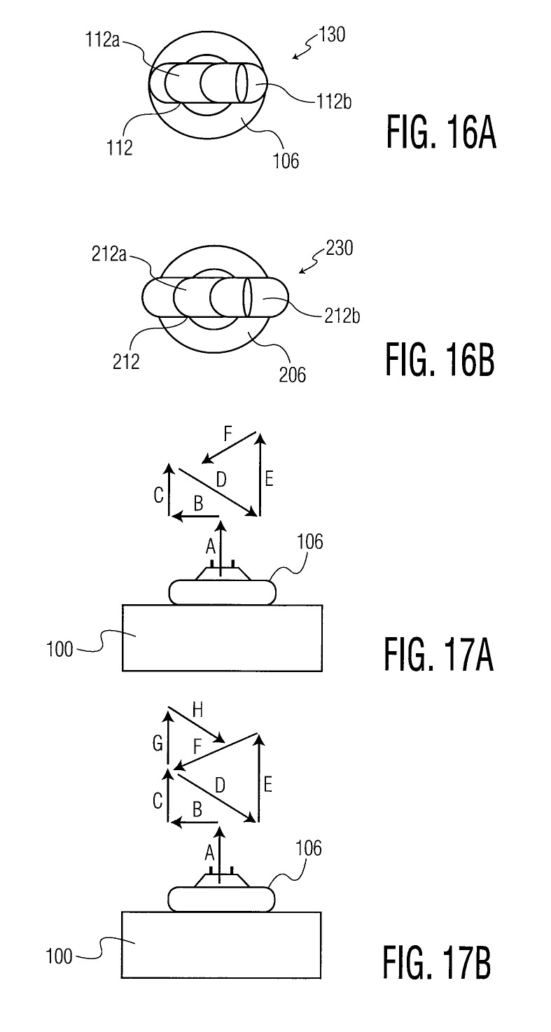

FIGS. 16A-16B are top view diagrams of conductive bumps formed in accordance with an exemplary embodiment of the present invention. More specifically, FIG. 16A illustrates a top view of conductive bump 130 (the same bump 130 shown in FIGS. 11 and 15B), including ball bump 106, third fold of wire 112, top surface 112a of third fold of wire 112, and wire tail/tip 112b of third fold of wire 112. As shown in FIG. 16A, the width of third fold of wire 112 (including wire tail/tip 112b) stays substantially within a footprint of ball bump 106.

According to certain exemplary embodiments of the present invention, conductive bumps are provided where a portion of one of more folds of wire extend beyond the footprint of the underlying ball bond. For example, FIG. 16B illustrates a top view of conductive bump 230 (which is similar in many respects to conductive bump 130, except for the width of one or more wire folds). Conductive bump 230 includes ball bump 206, third fold of wire 212, top surface 212a of third fold of wire 212, and wire tail/tip 212b of third fold of wire 212. As is shown in FIG. 16B, a width of third fold of wire 212 extends beyond a footprint of ball bond 206, thereby providing a larger target for bonding thereto (e.g., for bonding a length of wire thereto, as shown in the FIGS. 12-14). In such an embodiment, only the top fold of wire may have the increased width, or one or more of the additional folds of wire (i.e., the underlying folds of wire) may also have the increased width.

FIGS. 17A-17B are diagrams illustrating motions of forming conductive bumps in accordance with various exemplary embodiments of the present invention. More specifically, FIG. 17A shows exemplary motions used to form conductive bump 120 shown in FIG. 9A, and FIG. 17B shows exemplary motions used to form conductive bump 130 shown in FIG. 11.

Referring to FIG. 17A, a bonding tool 102 (e.g., capillary tool 102) is used to deposit ball bump 106 on a bond pad of semiconductor die 100 (bond pads on semiconductor die 100 are not shown in the Figures). At Motion A, with ball bump 106 still connected to the wire, the capillary is raised above the surface of ball bump 106. At Motion B the capillary is moved in a lateral (i.e., horizontal) direction, and at Motion C the capillary is moved in a vertical direction to payout a small length of wire. At Motion D, a first fold of wire is formed by moving the capillary down and horizontally. At Motion E the capillary is moved in a vertical direction to payout a small portion of wire, and at Motion F the capillary is moved down and horizontally (in the direction opposite to direction used to form the first fold) to form a second fold. At described above with reference to FIGS. 8-9A, the wire is then torn to separate the wire from the formed conductive bump.

Referring to FIG. 17B, Motions A-F are the same as those described above with respect to FIG. 17A. At Motion G, the capillary is raised, and at Motion H, the capillary is lowered and moved horizontally to form a third fold of wire. As described above with reference to FIGS. 9B-11, the wire is then torn to separate the wire from the formed conductive bump.

Although the present invention has been illustrated in connection with stand-off stitch bond type wire loops (See FIGS. 12-14), it is contemplated that the conductive bumps could be used in a number of different wire loops. For example, it is contemplated that a conductive bump according to the present invention could be positioned at either or both of the first and second bond sites.

Additionally, in certain applications (e.g., because of clearance issues and the like), it may be desirable to (1) position a first conductive bump having a certain number of folds of wire on the first bond site, and (2) position a second conductive bump having a certain number of folds of wire on the second bond site. The number of folds of wire for each of the first and second conductive bumps may be different from one another, as is desired to customize the wire loop.

The wire bonding techniques of the present invention may be implemented in a number of alternative mediums. For example, the techniques can be installed on an existing computer system/server as software (a computer system used in connection with, or integrated with, a wire bonding machine). Further, the techniques may operate from a computer readable carrier (e.g., solid state memory, optical disc, magnetic disc, radio frequency carrier medium, audio frequency carrier medium, etc.) that includes computer instructions (e.g., computer program instructions) related to the wire bonding techniques.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of forming a conductive bump using a wire bonding machine, the method comprising the steps of:
(a) depositing a free air ball bump on a contact pad of a semiconductor element;
(b) forming a first fold of wire on the deposited free air ball bump; and
(c) forming a second fold of wire on the first fold of wire.

2. The method of claim 1 wherein step (b) includes forming the first fold in a first direction, and step (c) includes forming the second fold in a second direction, the second direction being substantially opposite in comparison to the first direction.

3. The method of claim 1 wherein each of the free air ball bump, the first fold of wire, and the second fold of wire are each part of the same wire length, and they remain interconnected during the method of forming the conductive bump.

4. The method of claim 1 further comprising (d) forming a third fold of wire on the second fold of wire.

5. The method of claim 1 further comprising (d) forming additional folds of wire one on top of one another, beginning with forming a third fold of wire on the second fold of wire.

6. The method of claim 1 wherein at least one of the first fold or the second fold is formed to have a width that extends beyond a footprint of the deposited free air ball bump.

7. A method of bonding a wire between a first bonding location and a second bonding location using a wire bonding machine, the method comprising the steps of:
(a) forming a conductive bump at a second bonding location, the step of forming the conductive bump including:
(1) depositing a free air ball bump on a contact pad of a semiconductor element,
(2) forming a first fold of wire on the deposited free air ball bump, and
(3) forming a second fold of wire on the first fold; and
(b) extending a length of wire between the first bonding location and the formed conductive bump.

8. The method of claim 7 wherein step (2) includes forming the first fold in a first direction, and step (3) includes forming the second fold in a second direction, the second direction being substantially opposite in comparison to the first direction.

9. The method of claim 7 wherein each of the free air ball bump, the first fold of wire, and the second fold of wire are each part of the same wire length, and they remain interconnected during step (a).

10. The method of claim 7 wherein step (a) further comprises (4) forming a third fold of wire on the second fold of wire.

11. The method of claim 7 wherein step (a) further comprises (4) forming additional folds of wire one on top of one another, beginning with forming a third fold of wire on the second fold of wire.

12. The method of claim 7 wherein at least one of the first fold or the second fold is formed to have a width that extends beyond a footprint of the deposited free air ball bump.

13. A conductive bump comprising:
a free air ball bump portion of a length of wire;
a first fold of wire on the free air ball bump portion; and
a second fold of wire on the first fold of wire.

14. The conductive bump of claim 13 wherein each of the free air ball bump portion, the first fold of wire, and the second fold of wire are integral with one another.

15. The conductive bump of claim 13 additionally comprising a third fold of wire on the second fold of wire.

16. The conductive bump of claim 13 additionally comprising additional folds of wire one on top of one another, including a third fold of wire on the second fold of wire.

17. The conductive bump of claim 13 wherein at least one of the first fold or the second fold has a width that extends beyond a footprint of the free air ball bump portion.

18. A wire loop providing electrical interconnection between a first bonding location and a second bonding location, the wire loop comprising:
(a) a conductive bump positioned at the second bonding location, the conductive bump including a free air ball bump portion of a length of wire, a first fold of wire on the free air ball bump portion, and a second fold of wire on the first fold of wire; and
(b) a length of wire extending between the first bonding location and the conductive bump.

19. The wire loop of claim 18 wherein each of the free air ball bump portion, the first fold of wire, and the second fold of wire are integral with one another.

20. The wire loop of claim 18 wherein the conductive bump additionally comprises a third fold of wire on the second fold of wire.

21. The wire loop of claim 18 wherein the conductive bump additionally comprises additional folds of wire one on top of one another, including a third fold of wire on the second fold of wire.

22. The wire loop of claim 18 wherein at least one of the first fold or the second fold has a width that extends beyond a footprint of the free air ball bump portion.
